(19) United States
(12) Patent Application Publication
(10) Pub. No.: US 2026/0299116 A1
(43) Pub. Date: Oct. 1, 2026

(54) VELOCITY SEGMENTATION OF CAMERA IMAGE PIXELS USING RADAR DOPPLER MEASUREMENTS

(71) Applicant: GM GLOBAL TECHNOLOGY OPERATIONS LLC, Detroit, MI (US)

(72) Inventors: Oded BIALER, Petach Tikva (IL); Roy Uziel, Givatayim (IL); Yuval Haitman, Ramat-Gan (IL)

(21) Appl. No.: 19/089,763

(22) Filed: Mar. 25, 2025

(51) Int. Cl. G01S 13/86; B60W 30/14; G01S 13/58; G01S 13/931; G06T 7/215; G06T 7/246

(52) U.S. Cl. CPC G01S 13/867; B60W 30/143; G01S 13/58; G01S 13/931; G06T 7/215; G06T 7/248; B60W 2420/408; B60W 2554/404; G06T 2207/20084; G06T 2207/30252

(57) ABSTRACT

A vehicle includes a camera configured to generate an image in a path of the vehicle. A radar sensor is configured to transmit radio frequency (RF) signals in the path of the vehicle and to receive radar returns. A velocity segmentation module is configured to generate radial velocities for the radar returns, group the radar returns into R clustered radar returns, where R is an integer greater than zero, project the R clustered radar returns onto the image, identify R moving objects corresponding to the R clustered radar returns by segmenting R sets of image pixels with similar image features as pixels corresponding to the R clustered radar returns, respectively, and calculate R radial velocities for the R clustered radar returns, respectively, in response to radial velocities of the R clustered radar returns for each of the R moving objects, respectively.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to driver assistance systems for vehicles, and more particularly to velocity segregation of camera image pixels using radar Doppler measurements.

Vehicles include various levels of driver assistance (such as fully or partially autonomous vehicles). These vehicles rely upon data generated by sensors such as radio detection and ranging (radar) sensors, light detection and ranging (lidar) sensors, and/or images generated by cameras. When enabled, the driver assistance systems control steering, acceleration, and/or braking in response to the data generated by the sensors.

### SUMMARY

A vehicle includes a camera configured to generate an image in a path of the vehicle. A radar sensor is configured to transmit radio frequency (RF) signals in the path of the vehicle and to receive radar returns. A velocity segmentation module is configured to generate radial velocities for the radar returns, group the radar returns into R clustered radar returns, where R is an integer greater than zero, project the R clustered radar returns onto the image, identify R moving objects corresponding to the R clustered radar returns by segmenting R sets of image pixels with similar image features as pixels corresponding to the R clustered radar returns, respectively, and calculate R radial velocities for the R clustered radar returns, respectively, in response to radial velocities of the R clustered radar returns for each of the R moving objects, respectively.

In other features, a driver assistance system is configured to control at least one of a speed and heading of the vehicle in respond to the R radial velocities of the R moving objects. The velocity segmentation module identifies the R moving objects by identifying R sets of segmented pixels with similar image features as pixels corresponding to the R clustered radar returns, respectively.

In other features, the velocity segmentation module identifies the R sets of segmented pixels using a neural network. The neural network generates feature vectors for pixels of the image. The velocity segmentation module identifies selected pixels for the R sets of segmented pixels based on the feature vectors. The velocity segmentation module calculates the R radial velocities for the R sets of segmented pixels based on an average of the radial velocities of the radar returns in the R clustered radar returns.

In other features, the velocity segmentation module removes outliers from the R clustered radar returns. The velocity segmentation module selectively classifies the radar returns as one of static and dynamic based on an ego-vehicle velocity. The velocity segmentation module selects the radar returns that are dynamic for clustering and does not select the radar returns that are static for clustering.

A method for perceiving objects in a path of a vehicle includes generating an image in a path of the vehicle; transmitting radio frequency (RF) signals in the path of the vehicle and receiving radar returns; generating radial velocities for the radar returns; grouping the radar returns into R clustered radar returns, where R is an integer greater than zero; projecting the R clustered radar returns onto the image; identifying R moving objects corresponding to the R clustered radar returns by segmenting R sets of image pixels with similar image features as pixels corresponding to the R clustered radar returns, respectively; and calculating R radial velocities for the R clustered radar returns, respectively, in response to radial velocities of the R clustered radar returns for each of the R moving objects, respectively.

In other features, the method includes controlling at least one of a speed and heading of the vehicle in respond to the R radial velocities of the R moving objects. The method includes identifying the R moving objects by identifying R sets of segmented pixels with similar image features as pixels corresponding to the R clustered radar returns, respectively. The method includes identifying the R sets of segmented pixels using a neural network.

In other features, the neural network generates feature vectors for pixels of the image. The method includes identifying selected pixels for the R sets of segmented pixels based on the feature vectors. The method includes calculating the R radial velocities for the R sets of segmented pixels based on an average of the radial velocities of the radar returns in the R clustered radar returns. The method includes removing outliers from the R clustered radar returns.

In other features, the method includes selectively classifying the radar returns as one of static and dynamic based on an ego-vehicle velocity. The method includes selecting the radar returns that are dynamic for clustering and not selecting the radar returns that are static for clustering.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a radar sensor, a camera, and a controller including a velocity segmentation module according to the present disclosure;

FIG. 2 illustrates an example of velocity segregation of camera image pixels using radar Doppler measurements;

FIG. 3 is a flowchart of an example of a method for performing velocity segregation of camera image pixels using radar Doppler measurements and using the information to operate the vehicle autonomously according to the present disclosure; and

FIGS. 4 to 6 are images illustrating various example scenarios using velocity segregation of camera image pixels using radar Doppler measurements according to the present disclosure.

In the drawings, reference numbers may be reused to identify similar and/or identical elements.

### DETAILED DESCRIPTION

While the following disclosure relates to driver assistance systems for passenger vehicles, the systems and methods described herein can be used for other types of vehicles.

Advanced driver assistance systems (ADAS) control driving of the vehicle in partially or fully autonomous modes using a repeating cycle including a perception stage, a prediction stage, and a planning stage. During the perception stage, sensors of the vehicle provide sensor data and processing is performed on the sensor data to identify locations of objects in the path of the vehicle. During prediction and planning stages, the driver assistance system predicts where the vehicle and the objects will be during subsequent sampling intervals, evaluates various different vehicle control inputs relative to a desired path for the vehicle, and selects control inputs for the sampling interval.

The driver assistance systems determine how to adjust actuators (e.g., brakes, throttle position, and/or a steering wheel angle) to control speed, acceleration, braking, and/or heading of the vehicle. The sensors include one or more radio detection and ranging (radar) sensors, one or more light detection and ranging (lidar) sensors, and/or one or more cameras that generate different types of perception data.

The radar sensors transmit RF signals and receive returns (e.g., a radar point cloud) from objects in the path of the vehicle. Doppler is a radar measurement for each reflection point that is proportional to the radial velocity of the reflection point (radar return). The cameras generate images in the path of the vehicle. An ego-vehicle velocity Doppler component is removed and radial velocities are generated for the radar returns in the radar point cloud.

In addition, the radar returns are also used to determine the distance from the vehicle to the object causing the reflection from the vehicle. While radar sensors provide sparse data as compared to lidar sensors, radar sensors have several advantages over lidar sensors. Radar sensors have a longer range, are resistant to bad weather (such as rain or snow), and produce more useable Doppler measurements (due to the use of RF signals as compared to light used in lidar sensors).

Radar points that are located close together are grouped into clusters. The clustered radar returns are projected onto a corresponding image from the camera. Image features are generated based on RGB values of pixels corresponding to locations of the clustered and projected radar points. Nearby pixels with similar features are identified (or segmented) to form sets of pixels around the clustered and projected radar returns.

For example, the nearby image pixels may correspond to a vehicle such as a car, a motorcycle, or a truck. Radial velocities are determined for each of the sets of segmented pixels (based on the radial velocities for the corresponding clustered and projected radar points). In some examples, the radial velocities calculated for each of the sets of segmented pixels are equal to an average value of the radial velocities for the corresponding clustered and projected radar points.

For example, the driver assistance system receives radar returns, clusters the returns into first and second clusters, and projects the first and second clustered radar returns onto corresponding pixels of the image. First and second sets of image pixels, respectively, having similar features as the corresponding pixels in the clustered radar returns are identified (e.g., using a neural network) and segmented. More particularly, a neural network generates a feature vector or descriptor for each pixel. The feature vectors are then used to find similarity between image pixels. In other words, image pixels with similar features (obtained from the neural network) are segmented to the same cluster. For example, the first and second sets of segmented image pixels may correspond to a first vehicle and a second vehicle, respectively, in the path of the vehicle.

The radial velocities corresponding to the first and second clustered returns are used to generate overall radial velocities for the first and second sets of segmented image pixels, respectively. For example, the first and second sets of segmented image pixels can be assigned an average of the radial velocities for the radar returns corresponding to the first and second clustered radar returns. As can be appreciated, outliers can be removed prior to averaging or application of another function.

Information generated during the perception stage is used by the driver assistance system for the prediction and planning stages. Continuing with the above example, the first vehicle may be 10 meters in front of the vehicle and moving away from the vehicle at 6 meters/second (m/s) and the second vehicle may be 18 meters in front of the vehicle and moving closer to the vehicle at −5 m/s. With this information, the driver assistance system can predict that the first vehicle will be further away from the vehicle in the next sample(s) (and the probable location of the first vehicle) and the second vehicle will be closer to the vehicle in the next sample(s) (and the probably location of the second vehicle). The driver assistance system uses this information when evaluating various control inputs for the vehicle.

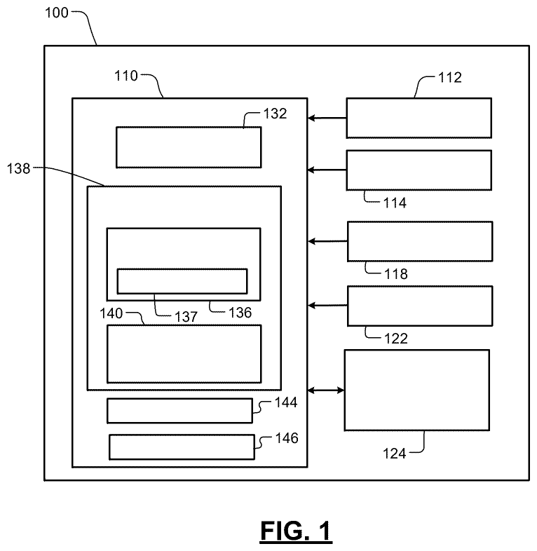

Referring now to FIG. 1, a vehicle 100 includes a controller 110 in communication with a global positioning system (GPS)/compass 112. The GPS/compass 112 is configured to determine a location and heading of the vehicle 100. The controller 110 is in communication with one or more radio detection and ranging (radar) sensors 114 configured to transmit RF signals and to receive radar returns from objects in a path of the vehicle 100. The radar returns from the one or more radar sensors 114 are stored in a radar point cloud 144.

The controller 110 may also communicate with one or more light detection and ranging (lidar) sensors 118 configured to transmit light and to detect lidar returns. The lidar return points from the one or more lidar sensors 118 are stored in a lidar point cloud 146.

The controller 110 includes one or more cameras 122 configured to generate images in the path of the vehicle 100. The vehicle 100 includes one or more vehicle control devices 124 such as an accelerator pedal, a brake pedal, a steering wheel, etc.

The controller 110 includes a driver assistance module 132 configured to perform partially and/or fully autonomous control of the vehicle 100. For example, the driver assistance module 132 is configured to adjust the actuators associated with the vehicle control devices 124 based on outputs of the one or more radar sensors 114, the GPS/compass 112, the one or more lidar sensors 118, and/or the one or more cameras 122.

The controller 110 includes a velocity segmentation module 138 configured to perform the processing on the radar returns and images as described above. The velocity segmentation module 138 includes a radar processing module 140 configured to calculate distances and radial velocities on radar returns in the radar point cloud 144 generated by the radar sensor 114. The radar processing module 140 is configured to perform Doppler calculations on the radar return data, remove an ego-vehicle velocity Doppler component, perform filtering of the Doppler calculations above a predetermined threshold, perform clustering of radar points, and/or other functions.

The velocity segmentation module 138 includes an image processing module 136 configured to project the clusters of radar points onto the images. The image processing module 136 compares image features of pixels near the pixels corresponding to the clustered and projected radar points. The image processing module 136 removes outliers in the image features per cluster.

The image processing module 136 segments image pixels with features similar to pixels corresponding to the clustered and projected radar returns and assigns a Doppler velocity for the segmented image pixels. In some examples, the image processing module 136 uses a neural network 137 to segment the related pixels.

The image processing module 136 outputs one or more Doppler segmented images with radial velocities and distances to the driver assistance module 132. The driver assistance module 132 uses the Doppler segmented images with the radial velocities and the distances to operate the vehicle 100 in a partially or fully autonomous driving mode.

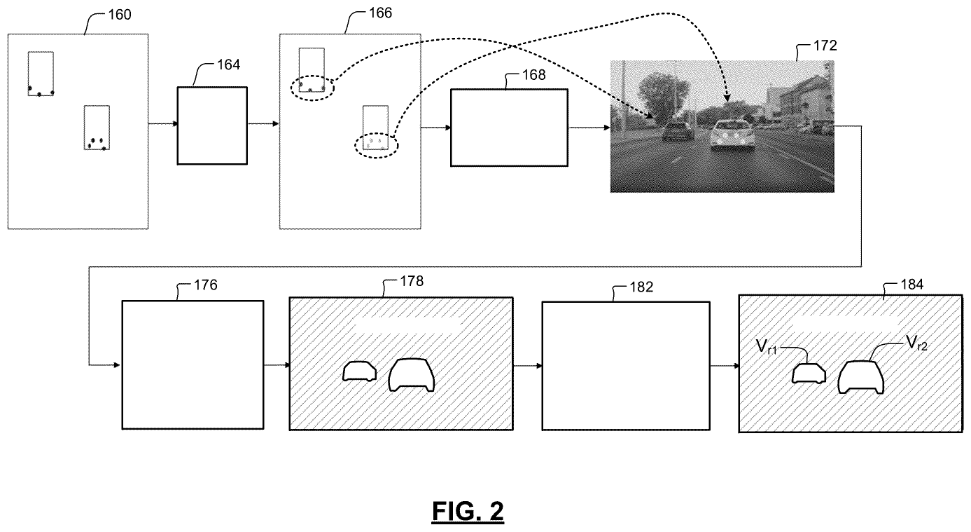

Referring now to FIG. 2, velocity segregation of camera image pixels using radar Doppler measurements is shown. At 160, a radar point cloud in a plan or bird's eye view orientation is shown. At 164, radar return points in the point cloud are clustered (e.g., radar points in similar locations are grouped (as shown in dotted circles in the plan view at 166)). At 172, the clustered radar returns are projected onto an image generated by one or more of the cameras.

At 176, nearby pixels with similar image features as those corresponding to clustered and projected radar returns are identified and segmented (e.g., forming a segmented sets of pixels) as shown at 178. At 182 and 184, radial velocities are assigned to each of the segmented sets of pixels (e.g., radial velocities averaged or another function is applied). The segmented images with the radial velocities and the distances are used by the driver assistance module when making decisions regarding control of actuators associated with one or more of the vehicle control devices.

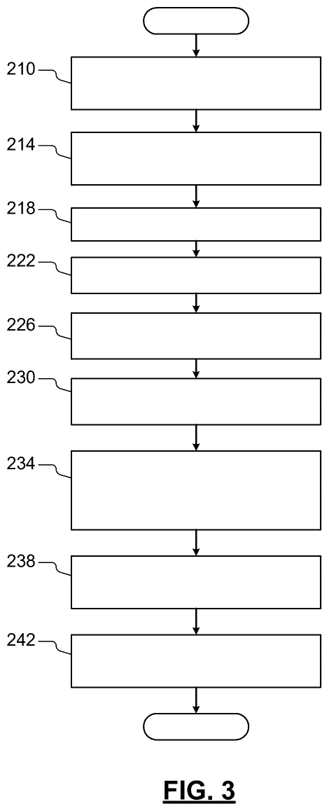

Referring now to FIG. 3, a method for performing velocity segregation of camera image pixels using radar Doppler measurements is shown. At 210, an ego-velocity Doppler component from a Doppler measurement is removed. For example, stationary objects are static or not moving and their radar returns can be eliminated for this analysis. At 214, dynamic radar reflection points with radial velocities above a predetermined threshold are filtered. At 218, the radar points that are in close proximity are grouped into clustered radar returns. In other words, radar return points from the radar point cloud that are located near one another are grouped together to form a cluster. Radar return points that are not located near other radar returns in a cluster are either associated with a different cluster or not associated with a cluster (e.g., a lone radar return)).

At 222, the radar return clusters are projected onto a corresponding image from the camera. In other words, the radar return clusters are projected onto the image at the location of the object that generated the radar returns.

At 226, image features from the pixels of the image corresponding to the projected point clusters are identified. For example, the images are fed to a neural network that generates a plurality of feature vectors based on red, green, and blue (RGB) pixel data of the images. The feature vectors are then used to identify nearby pixels that have similar feature vectors.

The neural network identifies sets of image pixels (or segmented set of pixels) with similar feature vectors as the pixels corresponding to the clustered and projected radar returns. Stated differently, RGB pixels corresponding to a vehicle will have feature vectors that are more similar to each other than to RGB pixels of the road, sky, sidewalk, or other background surrounding the object causing the reflection.

At 230, outliers are removed in the image features for each cluster. For example, radar returns corresponding to a static object may be located near or within the segmented set of pixels.

At 234, RGB pixels with features similar to images at the projected cluster points are segmented and combined with the image features already associated with the projected cluster points. The combined image is assigned a Doppler value (based on the radial velocities of the cluster points of the segments (with outliers removed at 230)). At 238, the annotated images with the point clusters and average radial velocities are used by the driver assistance system to adjust actuators associated with one or more vehicle control devices at 242.

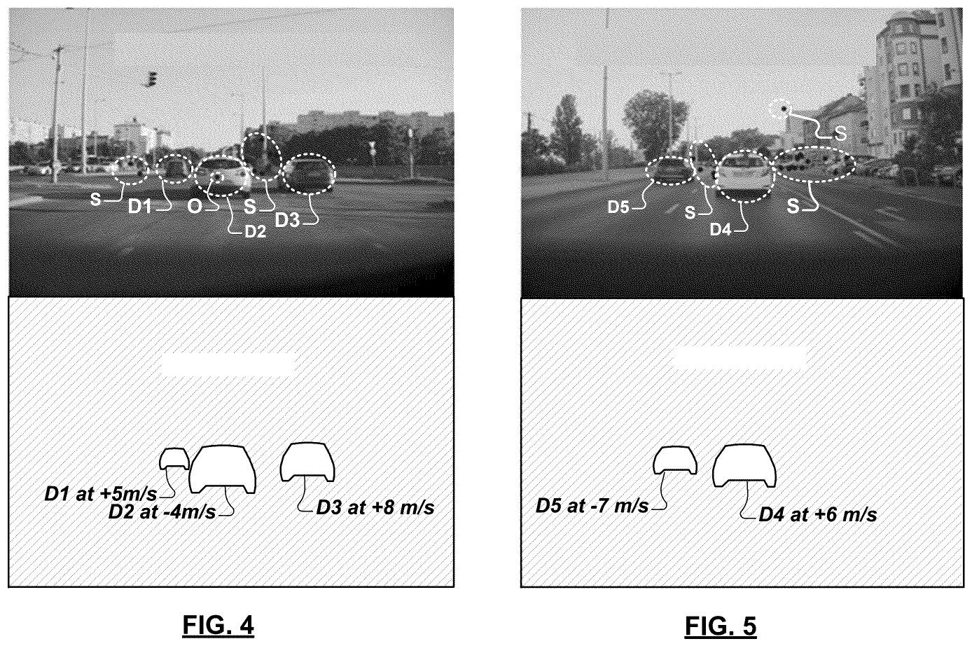

Referring now to FIGS. 4 to 6, example scenarios are shown that use radar Doppler measurements and velocity segregation of camera image pixels. In FIG. 4, radar point returns are processed, clustered, and projected onto an image. Three sets of image pixels with dynamic returns are identified at D1, D2 and D3. Static returns S are ignored. One outlier O is located in D3 and is removed from the calculation.

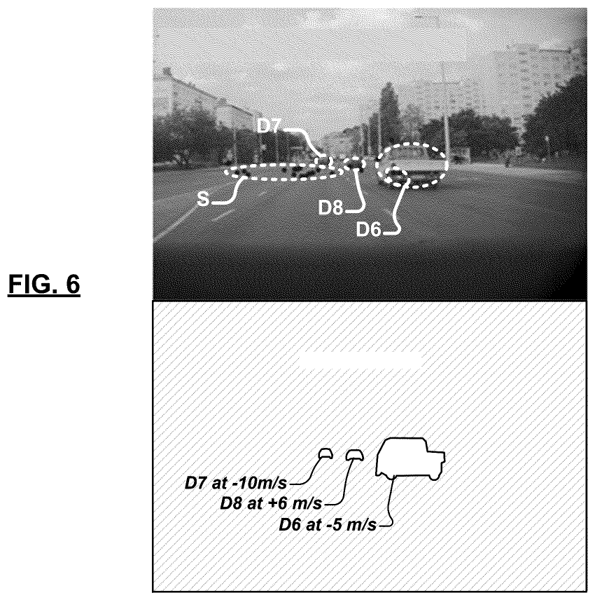

In FIG. 5, radar point returns are processed, clustered, and projected onto an image. Two sets of image pixels with dynamic returns are identified at D4 and D5. Static returns S are ignored. In FIG. 6, radar point returns are processed, clustered, and projected onto an image. Three sets of image pixels with dynamic returns are identified at D6, D7, and D8. Static returns S are ignored.

Segmenting image pixels based on their Doppler velocity (or radial velocity of the reflected returns) adds a valuable information for improving object detection, prediction, tracking, and driving planning. Standard images from the cameras lack direct motion information. The driver assistance system according to the present disclosure provides high-resolution motion segmentation in camera images using sparse radar Doppler measurements.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A vehicle comprising:
a camera configured to generate an image in a path of the vehicle;
a radar sensor configured to transmit radio frequency (RF) signals in the path of the vehicle and to receive radar returns; and
a velocity segmentation module configured to:
generate radial velocities for the radar returns;
group the radar returns into R clustered radar returns, where R is an integer greater than zero;
project the R clustered radar returns onto the image;
identify R moving objects corresponding to the R clustered radar returns by segmenting R sets of image pixels with similar image features as pixels corresponding to the R clustered radar returns, respectively; and
calculate R radial velocities for the R clustered radar returns, respectively, in response to radial velocities of the R clustered radar returns for each of the R moving objects, respectively.

2. The vehicle of claim 1, further comprising a driver assistance system configured to control at least one of a speed and heading of the vehicle in respond to the R radial velocities of the R moving objects.

3. The vehicle of claim 1, wherein the velocity segmentation module identifies the R moving objects by identifying R sets of segmented pixels with similar image features as pixels corresponding to the R clustered radar returns, respectively.

4. The vehicle of claim 3, wherein the velocity segmentation module identifies the R sets of segmented pixels using a neural network.

5. The vehicle of claim 4, wherein the neural network generates feature vectors for pixels of the image.

6. The vehicle of claim 5, wherein the velocity segmentation module identifies selected pixels for the R sets of segmented pixels based on the feature vectors.

7. The vehicle of claim 4, wherein the velocity segmentation module calculates the R radial velocities for the R sets of segmented pixels based on an average of the radial velocities of the radar returns in the R clustered radar returns.

8. The vehicle of claim 1, wherein the velocity segmentation module removes outliers from the R clustered radar returns.

9. The vehicle of claim 1, wherein the velocity segmentation module selectively classifies the radar returns as one of static and dynamic based on an ego-vehicle velocity.

10. The vehicle of claim 9, wherein the velocity segmentation module selects the radar returns that are dynamic for clustering and does not select the radar returns that are static for clustering.

11. A method for perceiving objects in a path of a vehicle, comprising:
generating an image in a path of the vehicle;
transmitting radio frequency (RF) signals in the path of the vehicle and receiving radar returns;
generating radial velocities for the radar returns;
grouping the radar returns into R clustered radar returns, where R is an integer greater than zero;
projecting the R clustered radar returns onto the image;
identifying R moving objects corresponding to the R clustered radar returns by segmenting R sets of image pixels with similar image features as pixels corresponding to the R clustered radar returns, respectively; and
calculating R radial velocities for the R clustered radar returns, respectively, in response to radial velocities of the R clustered radar returns for each of the R moving objects, respectively.

12. The method of claim 11, further comprising controlling at least one of a speed and heading of the vehicle in respond to the R radial velocities of the R moving objects.

13. The method of claim 11, further comprising identifying the R moving objects by identifying R sets of segmented pixels with similar image features as pixels corresponding to the R clustered radar returns, respectively.

14. The method of claim 13, further comprising identifying the R sets of segmented pixels using a neural network.

15. The method of claim 14, wherein the neural network generates feature vectors for pixels of the image.

16. The method of claim 15, further comprising identifying selected pixels for the R sets of segmented pixels based on the feature vectors.

17. The method of claim 14, further comprising calculating the R radial velocities for the R sets of segmented pixels based on an average of the radial velocities of the radar returns in the R clustered radar returns.

18. The method of claim 11, further comprising removing outliers from the R clustered radar returns.

19. The method of claim 11, further comprising selectively classifying the radar returns as one of static and dynamic based on an ego-vehicle velocity.

20. The method of claim 19, further comprising selecting the radar returns that are dynamic for clustering and not selecting the radar returns that are static for clustering.
